(19) United States
(12) Patent Application Publication
(10) Pub. No.: US 2009/0068631 A1
(43) Pub. Date: Mar. 12, 2009

(54) Web based educational system for collaborative learning

(76) Inventor: Chris Halliwell, Huntington Beach, CA (US)

Correspondence Address: Chris Halliwell, 217 Baltimore Ave, Huntington Beach, CA, 92648, US

(21) Appl. No.: 11/900,022

(22) Filed: Sep. 10, 2007

(51) Int. Cl. G09B 7/00

(52) U.S. Cl. 434/362

(57) ABSTRACT

A method and apparatus is disclosed for facilitating collaborative learning in an educational community via a web based educational system. In one embodiment, the method allows one or more of the educational participants to generate educational content, upload it to a document depository and teach it to other participants with the help of web based tools like web-conferencing, audio and video streaming, and web logging (blogging). The method also safeguards the quality of the generated educational content, by defining the role of the educational moderator and the access privileges that each class of participants has in using the web system's resources.

### FIELD OF THE INVENTION

The invention relates to Web based educational systems. In particular, it teaches a method and system for accruing educational material that is generated by the students or participants in the educational process and for utilizing it towards the goal of collaborative learning.

### BACKGROUND OF THE INVENTION

The advent of networked computers and the ease of sharing information on the World-Wide-Web have revolutionized many aspects of the educational process. It is now easier for teachers to disseminate relevant information about their course using the network via web pages, email lists etc. It is also easier to collect information from the students such as assignments, tests and others. Helmick teaches in U.S. Pat. No. 6,674,992 B2 titled “On-line educational system for document sharing” and incorporated herein by reference, how an instructor can create an electronic syllabus and how the students and the instructor can share messages and documents to facilitate the learning process.

The web can also enable the creation of on-line courses and the customization of those courses to various specialized groups of students. Vivian teaches in U.S. Pat. No. 7,013,325 titled “Method and system for interactively generating and presenting a specialized learning curriculum over a computer network” and incorporated herein by reference, how the instructor can collect demographic and personal information from each student and tailor the on-line curriculum to each student.

The examples referenced above teach how the instructor can utilize the information sharing power of the web to better disseminate the course's information and tailor it to each student's needs. However, the said information sharing power of the web can also enable a completely different paradigm for learning. It can transform the one-way, teacher-to-student information transfer to a two-way, student-to-student information transfer producing collaborative learning. It can enable students/participants to generate educational content, share it with other students/participants and re-enforce the course's core concepts.

Collaborative learning is most useful in educational environments where the core course concepts can be specialized in many different ways and applied to many different circumstances or cases. For example in executive business education a participant may learn several core concepts of business management including marketing, sales strategy, pricing methods, or other. Then the participant may have to apply those core concepts to a specific industry or a specific market or a specific product or other specific case. By applying the core techniques to specific situations, the participant is actually generating additional educational material by further refining the course's techniques to the specific problem at hand.

Similarly, in many situations involving training participants in technical concepts, there can be opportunities for specializing the learned technical concepts into specific products, designs, implementations or other cases. For example, a course that teaches core telecommunications concepts like digital encoding, modulation, transmission or other, could allow participants to apply those concepts to the design of specific wireless, optical, cable or other transmission systems. This additional educational material that is generated by the participants can be used, according to the teachings of the invention herein, to re-enforce learning of the core concepts for all participants.

Prior art teaches how an instructor can design an on line course, and share a syllabus and other documents among students. It does not teach however, how the students can be empowered by the system to teach other students about the educational material they have developed on their own and beyond the basic concepts taught by the instructor. Therefore, prior art does not teach how to achieve collaborative learning.

The current invention teaches how to create an educational system that allows the educational participants to create educational content, share it with other participants and achieve collaborative learning. It also teaches a method for the orderly development of collaborative learning, where the teacher/moderator maintains control of the educational process and does not allow any compromise to the course's educational standards.

### SUMMARY

The method and apparatus described herein overcomes the drawbacks of prior art and enables the educational moderator to collect additional educational material from one or more participants in the educational process, make it available to the other participants, and allow one or more of the participants to teach the other participants the said additional educational material. It is contemplated that the actions of collecting, disseminating and teaching the additional educational material are performed via the web as will be disclosed herein.

In one embodiment of the invention, the educational moderator can be the teacher of a technical or business course, the teacher of a continuing education course or the teacher of an executive education course. In another embodiment, the educational moderator can be a business consultant, a professor, an on-line instructor, a corporate trainer, or other individual tasked with teaching a set of skills or concepts to the participants in the educational process.

The educational participants may include but not limited to students taking a particular course, business executives trained by a business consultant, engineers acquiring new technical skills or technicians trained in a new product or technology.

The invention disclosed herein enables the educational participants to develop additional educational material of their own (related to the core concepts being taught), disseminate it to other participants and teach this material to them. In this way, one or more of the educational participants can become educational leader-participants.

In one embodiment, these actions can take place at a later time, after the completion of the course or training program. For example, a number of business executives may be trained in a novel marketing technique by a marketing consultant/trainer. Subsequent to this training, one or more of the business executives/participants may apply the said novel marketing technique to a particular industry and/or product line with some success. The invention disclosed herein allows the said one or more participant to teach the application of the novel marketing technique to the specific industry or product to other business executives/participants. This is accomplished by the generation of additional educational material. In this example, the additional educational material can be a case study where the application of the novel marketing technique is explained. The case study can be described in a document, a set of presentation slides, an audio file or other suitable format.

In another example, a number of engineers may be trained in a novel design methodology. Subsequent to this training, one or more engineers may apply the novel design methodology to a different product or in combination with other design tools not originally envisioned by the instructor. This activity may result in additional educational material in the form of a technical paper, a design case study, a set of charts or performance results or test measurements.

The case study or other additional educational material requires a means of dissemination to the other participants in the educational process. The current invention teaches the use of a web based system for the dissemination of the additional educational material. In one embodiment, the web based system comprises a server or network of servers equipped with appropriate software, able to maintain a depository of additional educational material provided by the educational participants. It also comprises a web interface, through which the participants can access the additional educational material. In one embodiment, the web interface comprises a web page or set of web pages with appropriate links to the deposited additional educational material. It also comprises of a means to upload the said additional educational material to the depository from the participant's computer.

The web based system can also comprise means to teach the additional educational material to other participants, other than by simply downloading the said material. In one embodiment of the invention, the means to teach the material may include a web conferencing/presentation software facility, enabling the leader-participant to teach the additional educational material to the other participants, by presenting figures, charts, spreadsheets or other visual and/or auditory elements that can help convey the core ideas of the additional educational material. In another embodiment of the invention, the means to teach the material may include a bulletin board or web-log software facility, where the leader-participant can lead an on-line discussion about the additional educational material. In yet another embodiment, the means to teach the material may include the ability for the educational moderator to interview or ask questions of the educational leader-participant related to the additional educational material. The audio and video of this interview may be available to the other participants in an on-line manner via real time web conferencing and/or in an off-line manner via an audio and video server depository system.

The judicious use of such a collaborative learning web based system (as described above) can harness the creativity of the educational participants/students, can augment the instructors base of educational material, can specialize the material and make it more relevant and interesting

The introduction of a collaborative learning web based system in the educational process should be done with extreme care, if we are to maintain an orderly educational experience. A free for all access to the educational material depository and/or the bulletin board and web conferencing resources of the system can create a chaotic and unwieldy situation. It can hide the high quality educational contributions of some participants in a sea of low quality material, discourage users from seeking useful information in the system, and degrade the standards and overall quality of the educational experience.

For this reason, the importance of the educational moderator is paramount in the successful use of the system disclosed herein. The moderator is the person that bears ultimate responsibility for the quality and success of the collaborative learning process. In one example, the moderator is the teacher of related courses or material to the subject of the web based collaborative learning. In alternative embodiments, the moderator may be associated to the on line collaborative community in a different capacity. In all cases, the moderator has the authority to regulate the material on the web learning system and enforce its policies. This invention teaches a method which allows the moderator to exercise control on the quality of the contributed educational material and the use of the web system resources.

It is contemplated that the disclosed method may not restrict access to the educational material. Access to the documents, presentations, interviews or other material in the depository may be available to all participants. In one embodiment, access may be available to the general public. It is contemplated however, that all participant contributions to the depository will be under the strict control of the educational moderator. The privilege of adding educational material to the depository is bestowed only upon participants whose work meets some minimum quality or other criteria, and is at the discretion of the moderator. Participants who possess that privilege form the class of contributing-participants.

The additional privilege of actively teaching the educational material via the resources of the web system (bulletin board, web conferencing etc.) is also at the discretion of the educational moderator. Participants who possess that privilege form the class of leader-participants.

The moderator based method for controlling the quality of the contributed material is not intended to stymie the creativity of the participants or discourage them from contributing. In fact, it is envisioned as a two-way process, where the moderator provides guidance and helps the participant improve the material as well as shape it into a form that is easiest for other participants to absorb. For example, if the participant is contributing a business case study or a technical study he or she may be guided to conform to a general format that is easier to follow and also preserves a uniform feel for the depository.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

FIG. 1 illustrates a diagram of an example embodiment of a web based environment for collaborative learning and sharing of student generated educational material

FIG. 2 illustrates a block diagram of an example software embodiment of a web based educational system

FIG. 3 illustrates a block diagram of an example embodiment of a system for moderating the teaching resources of the web based system

FIG. 4 illustrates a block diagram of an example embodiment of a method for moderating the contributions of educational material to the web based system

FIG. 4A illustrates a block diagram of an example embodiment of a method for moderating the teaching resources of the web based system

FIG. 5 illustrates a block diagram of an example embodiment of a method for developing a case study

### DETAILED DESCRIPTION

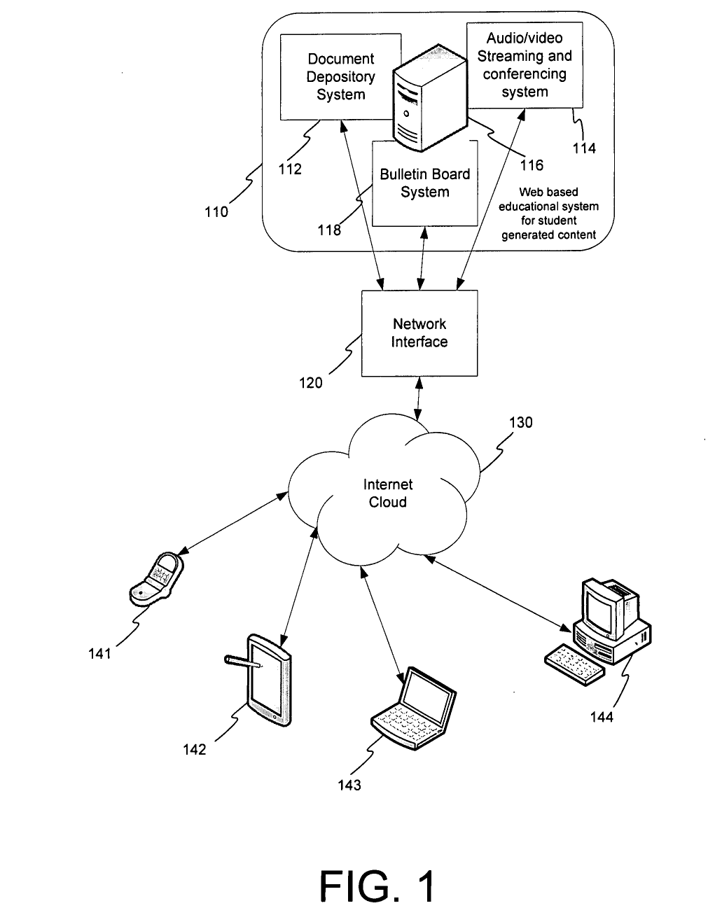

Before discussing the particular components of the claimed system and method, we discuss an example environment for use of the invention, in order to aid the reader in his/her understanding. FIG. 1 shows a plurality of terminal stations through which educational participants can access the internet. In particular, 144 depicts a desktop computer connected to the internet, 143 a laptop computer connected to the internet, 142 a tablet computer connected to the internet and 141 a cell-phone or PDA connected to the internet. Naturally, these are just examples of terminal devices users can use to connect to the internet, and hence the invention is not intended to be limited to the use of these particular devices. Through these devices and through the internet cloud 130, the educational participants can reach the web based educational system. The internet cloud 130, can comprise routers, networked computers, communication links and other internetworking infrastructure required to convey data from the terminal devices to the web based educational system and vice versa, via the system's network interface 120.

The web based educational system 110 comprises of software and hardware components. The main functional blocks of the system as experienced by the user, comprise a document depository system 112, an audio/video streaming and conferencing system 114 and a bulletin board system 118. The document depository system 112 may support the functions of uploading, downloading, archiving, indexing, searching and cataloging the available set of documents among others. The audio/video streaming and conferencing system 114 may support viewing slides or video presentations, listening to speaker recordings and participating in on-line conferences or interviews among others. The bulletin board system 118 may support messaging, web-logging, text and video chatting and other means of enabling discussions among the participants, for example as a follow-up to an on-line conference on a specific topic.

All three functional blocks of the system 110 may be implemented in a combination of software and hardware. A typical embodiment may comprise a software implementation of the three blocks, running on a web server hardware platform 116. Other embodiments are possible, for example on server clusters, networked computers or other.

The development of web pages, web sites and web based services like audio streaming is well understood at the time of this writing, and the implementation of such functions is apparent to one with ordinary skill in the art. For this reason, in this disclosure we focus our teaching on how to harness the power of such web services for educational purposes, rather than how to implement each web based service on a specific software/hardware platform.

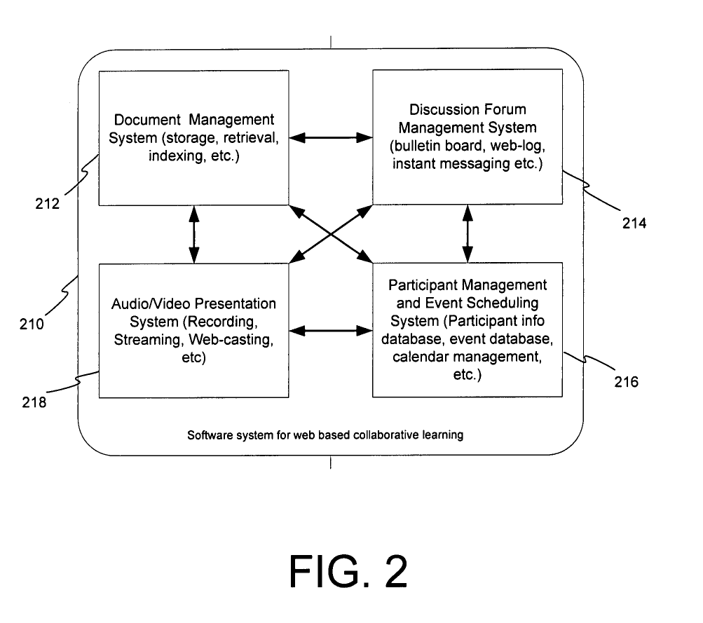

FIG. 2 departs from the view of the system, as experienced by the user, and depicts the actual software building blocks of the educational system 210. The system comprises of a document management and archival system 212, an audio/video presentation and conferencing management system 218, a discussion forum management system 214 and a participant management and event scheduling system 216. The document management system 212 comprises of a data-base of contributed documents (text, slides, audio, video) with means of archiving, indexing, searching, backing up, etc. the available content. This block provides document management services to the other software blocks of the system. The presentation and conferencing block 218 provides multimedia streaming services to the users including but not limited to web-casting, recording, video and audio conferencing, etc. It interacts with the document management block and the other blocks of the system. The discussion forum management block 214 supports on-line discussions and web logging and has features for indexing and archiving of the discussion content. It interacts with the participant management system 216 described next and the other subsystems. The participant management and event scheduling system 216 comprises of a participant information data base and appropriate software which allows participants to sign up for web conferencing events and participate in web discussions among others. It also allows the moderator to monitor the participant activity on the system, schedule web conference activities and accept or reject uploaded educational material.

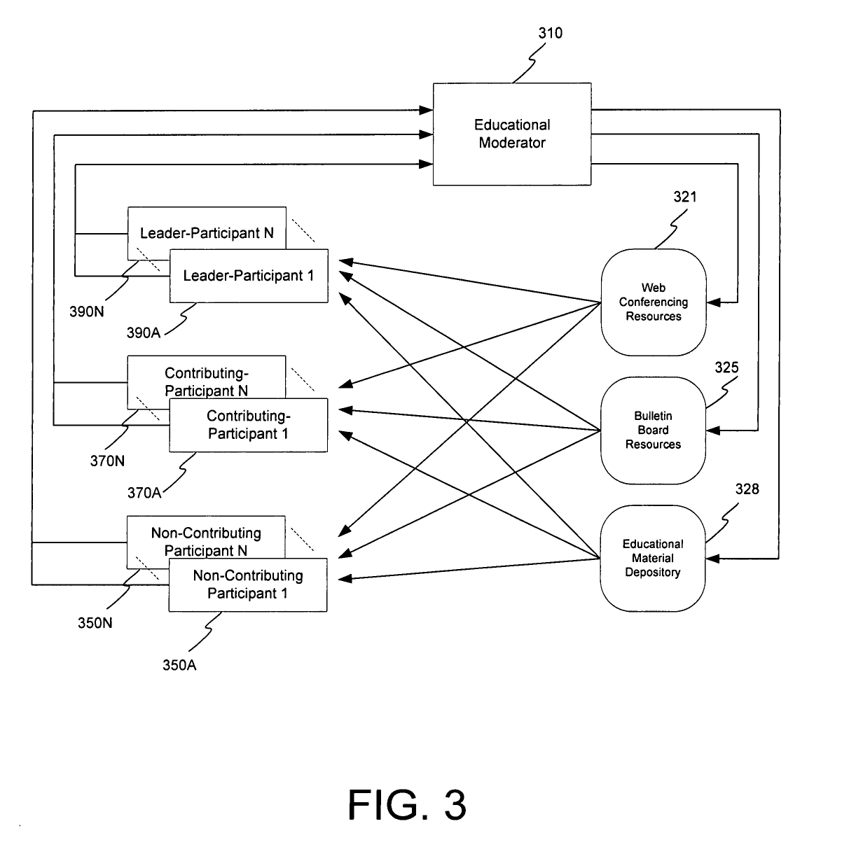

The role of the moderator/teacher in this educational system is further explained in FIG. 3. In this block diagram, the educational moderator 310 is in full control of the educational material available in the system as well as the educational activities the system supports.

It is envisioned that the moderator/teacher may initiate the educational process by teaching the core concepts of the subject matter in either face-to-face and/or web based interactions with the student participants. Then, the moderator can utilize the disclosed system to solicit additional educational material from the participants, which specialize the core concepts to areas most familiar to each participant based upon his/her experience. However, the moderator should be in full control of the material accepted into the system so that quality standards are maintained. The moderator should also be in full control of the other system resources, like web conferencing and discussion forum resources.

From the point of view of participant access and privileges on the system, the population of students/participants can be classified into three groups. The group with the least amount of privileges comprises of 350A-350N in FIG. 3. They are called non-contributing participants and only have read/download access to the educational material in the depository 328. In one embodiment, the system may be open for download access to the general public and hence, the group of non-contributing participants may not be limited to students in a particular class. The non-contributing participants may also have access to the web conferencing resources 321 and the bulletin board/web logging resources 325. In one embodiment they may also be able to contribute questions or opinions to the web conference and/or the web logs. It is not envisioned that the moderator will approve each document download for each non-contributing participant as the philosophy of the system is to provide maximum access to the content while being more strict on the material getting into the system. The moderator may however control use of the other system resources 321 and 325.

The next level of privileges is enjoyed by the group of contributing participants comprising of 370A-370N in FIG. 3. These participants are able to contribute documents to the depository 328 (e.g., business cases or technical reports). The uploading process however is under the review, improvement, approval and consent of the moderator 310 as shown in the figure. In one embodiment, the ability to upload documents may be restricted to the moderator, and a participant can only contribute material to the system indirectly, through the moderator.

The highest level of system privileges is bestowed upon the group of leader-participant, comprising of 390A-390N. These participants not only have contributed educational material to the system, but have been qualified and selected by the moderator to assume a more active role is disseminating their contributed material and teaching in to the other participants. A leader participant may be allowed to lead a web-log discussion using 325 on the topic of his/her contribution, may be allowed to lead a web presentation using 321 on the topic of his/her contribution, or may in other ways utilize the resources of the system to teach other participants. All this activities are again under the review, improvement and consent of the moderator.

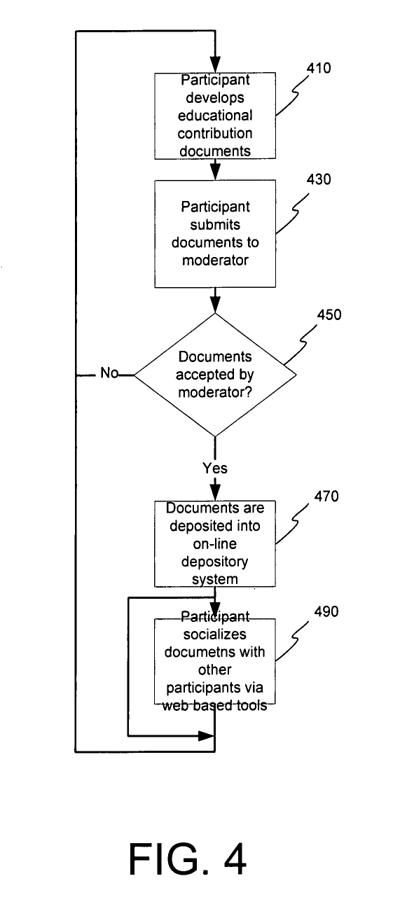

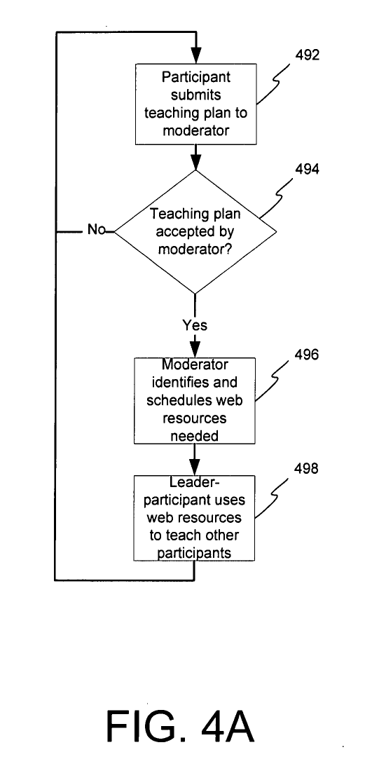

FIG. 4 further explains a method by which a contributing participant can upload educational contribution documents to the document depository. In the first step 410 of the method, the participant prepares the documents related to the educational contribution. In one embodiment, these documents may comprise a business case study. In another embodiment, it may comprise a technical paper, engineering report or scientific analysis. The step 410 may be undertaken by a single participant or a group of participants. It may be accomplished with or without the collaboration and help of the teacher/moderator. However, the resulting documents in their final form always need to be submitted to the moderator for approval as shown in step 430. The submission may be through functionality provided by the web system or by some other means.

The moderator consequently makes a determination regarding the submitted documents in step 450. If the moderator's educational criteria are satisfied (quality, novelty, relevance or other criteria established by the moderator), then the process advances to step 450. Otherwise, the process returns back to step 410 and the participant is required to further improve the quality of his/her material.

In step 470 the relevant documents are uploaded to the depository system. In one embodiment, means of access to those documents are also incorporated to the system in this step. Those means may comprise insertion of web links to those documents in relevant web pages of the system. Those means may also comprise addition of indexing or other means to facilitate the system's search functionality.

Depending on the level of privileges of the participant and/or the importance of the material contributed the process may include the optional step of 490, where the participant takes active steps to disseminate the information in the documents, socialize the material with other participants and convey or teach the concepts in his/her documents to other participants. This activity is only limited to leader participants and involves the creation of a teaching plan, via which the leader participant with harness the resources of the web system to achieve his/her educational goal. FIG. 4A further explains the details of step 490.

In Step 492 the leader participant submits his/her teaching plan to the moderator. In one embodiment, the teaching plan may comprise the presentation of a set of slides (related to the participant's contribution) to the other participants, via the conference resources of the web based system. In another embodiment, the teaching plan may comprise an on-line interview of one or more experts by the participant and/or by the moderator, on the concepts of the contributed material. The interview may be accessed by the other participants via the web in real time or at a later time. Alternatively, the leader participant may be interviewed by the moderator or other to answer questions about his/her contribution. In yet another embodiment, the teaching plan may comprise an on line discussion or web-logging, led by the leader participant and/or the moderator on the concepts developed in the contributed documents. As may become apparent to the skilled in the art, there are numerous embodiments and variations of the way a teaching plan may be constructed to achieve the teaching objectives of the leader participant and the moderator. As such the present invention is not limited to a specific embodiment of the said teaching plan.

In step 494, the moderator determines whether the submitted teaching plan is acceptable based on his/her criteria (feasibility, quality, expense, and/or others). If the decision is negative, the method returns back to step 492, where the leader participant is required to modify and improve his proposal, and submit a new teaching plan. If the decision is positive, the method advances to step 496. In that step, the moderator identifies and books the required resources from the web based system. For example, video streaming resources and/or audio conferencing resources may be required to implement a web based presentation, which may be part of the teaching plan. In this step, the means for the other participants to access these resources at the scheduled times are also provided. For example, login codes or passwords may be required to connect to the web conferencing resource, which have to be provided to the other participants. Finally, in step 498, the leader participant utilizes the system's web based resources to execute the teaching plan and teach other participants the concepts of his/her contribution.

The method described in this disclosure for stimulating collaborative learning, can be adapted to a face-to-face traditional classroom teaching environment. However, the power of the web based system lies in the ability to connect participants from different geographic areas. This is important as the fruits of collaborative learning (e.g., business cases and presentations) may only be available after a course or class is over. For example, people from different geographies may get together for a short amount of time to attend a conference, workshop, short course or other specialist training. Then, they may disperse back to different geographies and have no opportunity to share the results of applying their training to their special area with their fellow students/participants. The web based system described here allows them to follow up on the skills learned, and reinforce learning among the participants, long after the course or training is over.

This feature of the collaborative learning system is also useful for teaching concepts that require repeated exposition over a long period of time. For example, complex business strategy concepts may be hard to acquire is a short period of time, but need to be reinforced by experience. The web based learning system can provide educational opportunities that are time-dispersed (as well as geographically-dispersed) and allow participants to exploit the personal experience of others instead of waiting for personal experience to accumulate. Over the years, they can focus on different material that is suitable for their maturity level as the latter changes.

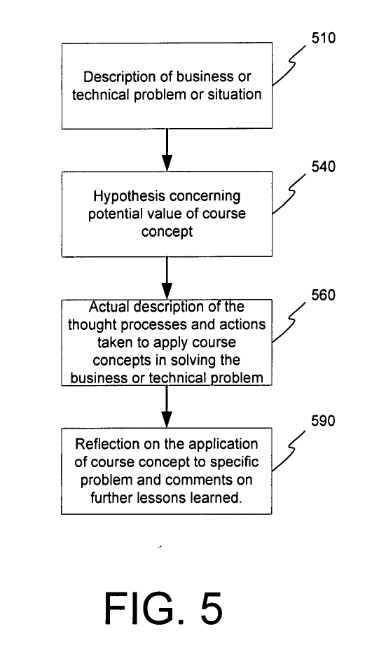

FIG. 5 describes a method for developing a contributed educational document (e.g., a business case or a technical report) so that it is maximally accessible by other participants and most useful. In step 510, the document begins with a description of the business situation or technical problem to be addressed. In one example, the contributed educational material may discuss the application of a novel marketing technique in the introduction of a new product. In this example, step 510 may discuss the market conditions prior to the introduction of the product, or the competitive landscape, or other subject matter that illustrates the difficulties, obstacles or challenges that were present in the introduction of the product to market. In step 540, a hypothesis is discussed concerning the potential applicability of one or more course concepts to the solution of this marketing problem. In one example, the course concept may be a marketing strategy that may be applicable to the specific market and competition environment. This step may include discussions on the potential problems with the application of the course concept, risks, downsides, but also potential benefits and rewards,

In step 560, the actual narrative is presented of the real life events that happened when the prior thought process was transformed into action, when the course concept was applied through concrete actions. These actions are described and the reaction to these actions is also described. The level of success or failure of the actions is presented. In one example, this step may describe the steps taken for the introduction of a new product and the reaction of the market and the competition.

In step 590, a reflection on the application of the course concept to the specific problem is presented. Lessons learned are discussed, successful elements of the course concept are pointed out and suggestions for modifications or improvements are proposed.

What is claimed is:

1. A method for re-enforcing educational concepts among a community of on-line educational participants, the method comprising:
At least one participant generating educational content describing business or technical applications of said educational concepts
Sharing the educational content generated by the at least one content generating participant with other participants on line
Other participants interacting with said at least one content generating participant via on line educational activities

2. The method of claim 1, where the means of generating content is via a participant generated document

3. The method of claim 1, where the means of generating content is via a participant generated audio file

4. The method of claim 1, where the means of generating content is via a participant generated video file

5. The method of claim 2, where the participant generated document is a business case study

6. The method of claim 2, where the participant generated document is a technical case study

7. The method of claim 1, where the means of sharing content is an on-line file archival system

8. The method of claim 1, where the means for other participants to interact with said at least one content generating participant is via web-log (blog) discussions

9. The method of claim 1, where the means for other participants to interact with said at least one content generating participant is via on-line conferencing

10. A method for moderating a collaborative learning process in an on-line educational community, the method comprising:
At least one participant generating educational content
The said at least one participant generating a plan of activities for disseminating and teaching the educational material to other participants on-line
The moderator of the on-line educational community approving the activities for disseminating and teaching the educational material
The moderator and the at least one participant securing the required on-line resources and executing the activities for disseminating and teaching the educational material

11. The method of claim 10, where the generated educational content is a business case document

12. The method of claim 10, where the generated educational content is a technical document

13. The method of claim 10, where the dissemination and teaching activities comprise uploading the document to the web-based document depository system

14. The method of claim 10, where the dissemination and teaching activities comprise the use of a web log (blog) bulletin board system

15. The method of claim 10, where the dissemination and teaching activities comprise an on-line presentation by the at least one content generating participant

16. The method of claim 10, where the dissemination and teaching activities comprise an on-line interview of at least one content generating participant by a panel of one or more experts

17. A system for re-enforcing educational concepts among a community of on-line educational participants, the system comprising:
A means for storing the educational content generated by the participants
A means for other participants to access the educational content on line
A means for other participants to interact with content generating participants via on line educational activities

18. The system of claim 17 where the means of storing the educational content is an electronic document archival system

19. The system of claim 17 where the means of interacting with content generating participants comprises an audio and video web conferencing system

20. The system of claim 17 where the means of interacting with content generating participants comprises a web log (blog) bulletin board system

21. A method for controlling the quality of collaborative learning among a community of on-line educational participants, the method comprising:
A moderator who has the power to bestow and withdraw all privileges to all other participants of the on line educational community
At least one teaching participant, who generates educational content, and with the approval of the moderator uploads it to the web based educational system, actively disseminates and teaches it to other participants
At least one contributing participant, who generates educational content, and with the approval of the moderator uploads it to the web based educational system
At least one participant, who accesses the educational content and learns from it
